(19) United States
(12) Patent Application Publication
(10) Pub. No.: US 2023/0035489 A1
(43) Pub. Date: Feb. 2, 2023

(54) REMOVAL SYSTEM FOR ADDITIVE MANUFACTURING ARTICLES

(71) Applicant: Sintavia, LLC, Hollywood, FL (US)

(72) Inventors: Timothy MacGregor Webster, JR., Boca Raton, FL (US); Tristan Keith Peyton, Tamarac, FL (US); Connor Thomas Moody, Fort Lauderdale, FL (US)

(73) Assignee: Sintavia, LLC, Hollywood, FL (US)

(21) Appl. No.: 17/500,183

(22) Filed: Oct. 13, 2021

Related U.S. Application Data
(60) Provisional application No. 63/227,670, filed on Jul. 30, 2021.

(51) Int. Cl. B22F 12/88; B22F 3/24

(52) U.S. Cl. CPC B22F 12/88; B22F 3/24; B33Y 10/00

(57) ABSTRACT

The present disclosure provides a system for aiding in the removal of an article of manufacture from a build plate. The system may include a catch mechanism, namely a catch basket, a support surface to which the catch mechanism is mounted and a net disposed across the catch basket. The support surface may include a spring mechanism. The net may be disposed of at a distance above a bottom portion of the catch basket.

### CROSS-REFERENCE TO RELATED APPLICATION

This patent application claims the benefit of priority to U.S. Provisional Patent Application No. 63/227,670 filed on Jul. 30, 2021, the disclosure of which is hereby incorporated by reference in its entirety and is made part of the present U.S. utility patent application for all purposes.

### FIELD OF THE DISCLOSURE

The present disclosure related to a system aiding in the removal of an article of manufacture produced by an additive manufacturing from a build plate.

### BACKGROUND OF THE DISCLOSURE

Additive manufacturing provides a process for manufacturing three-dimensional metal articles utilizing layer-by-layer formation of the article based on computer aided design (CAD) data.

Generally a metal powder is applied to a work surface, e.g., a build plate and the metal is subjected to one or more of a sintering, curing or melting processes. The process is repeated multiple times building an article of manufacture layer-by-layer. The resulting articles of manufacture may have complex shapes and have a wide variety of metallurgical properties. The additive manufacturing articles find utility in optimized parts in the aerospace, defense, power, oil and natural gas, and automotive industries.

The finished article, however, must be removed from the build plate. Typically, such removal has been accomplished using a cutting blade using a band saw. However such saws are not designed for that type of cutting and often leave unwanted material on the part, or on the build plate because the saw and cutting are not sufficiently exact.

Another alternative is to use electrical discharge machining (EDM). In EDM, an electric spark is created between an electrode and a conductive workpiece or part, i.e., the article of manufacture. The spark takes place in a bath of a dielectric liquid such as deionized water. The conductivity of the dielectric liquid is controlled and the water acts as a coolant and may flush away unwanted metal particles. The electric spark may be carefully controlled and localized so that very precise cuts of anything on the build plate may be removed.

EDM uses an extremely thin metallic wire to cut the articles of manufacture from the build plate. The wire is vertically oriented to the build plate. A limitation of using EDM is that care must be taken to avoid having the article of manufacture, or anything else, attached to the build plate touching the wire or bouncing off of it. If anything metal removed from the build plate comes into contact with the wire, the machine eventually short circuits. Moreover, many of the articles are heavy and have unique geometries and can damage the bottom of the EDM if merely dropped.

Thus, there is a need for a removal system that safely and efficiently removes an article of manufacture from the build plate of an additive manufacturing system.

### SUMMARY

The present disclosure provides a system for aiding in the removal of an article of manufacture from a build plate. The system may include a catch mechanism, namely a catch basket, a support surface to which the catch mechanism is mounted and a net disposed across the catch basket. The support surface may include a spring mechanism. The net may be disposed of at a distance above a bottom portion of the catch basket.

### BRIEF DESCRIPTION OF THE DRAWINGS

Exemplary embodiments are illustrated in the referenced figures of the drawings. It is intended that the embodiments and figures disclosed herein are to be illustrative rather than limiting.

FIG. 1 is a perspective view of an electric discharge machine (EDM) which may be used with a removal system for a removal of an article of manufacture made by additive manufacture from a build plate according to an embodiment.

FIG. 2 is a perspective view of the electric discharge (EDM) of FIG. 1 and the removal system.

FIG. 3 is a perspective view of the electric discharge machine (EDM) shown in FIG. 2 with the article of manufacture on the build plate and the removal system positioned to catch the article of manufacture once removed using EDM according to an embodiment.

FIG. 4 is a close up perspective view of the removal system according to an embodiment.

### DETAILED DESCRIPTION

Several embodiments will be described more fully in reference to the accompanying figure. However, this disclosure should not be construed as limited to the embodiments set forth herein. Rather, these embodiments are provided so that this disclosure will be thorough and complete, and will fully convey the scope of the invention to those skilled in the art. In the drawing, like numbers refer to like elements throughout. Thicknesses and dimensions of some components may be exaggerated for clarity.

The terminology used herein is for the purposed of describing particular embodiments only and is not intended to be limiting of the invention. As used herein, the singular forms “a,” “and,” and “the” are intended to include the plural forms as well, unless the context clearly indicates otherwise.

It will be understood that when an element is referred to as being “attached,” “coupled” or “connected” to another element, it can be directly attached, coupled or connected to the other element or intervening elements may also be present. In contrast, when an element is referred to as being “directly attached,” “directly coupled” or “directly connected” to another element, there are no intervening elements present.

All patents, patent applications and publications referred to herein are incorporated by reference in their entirety. In case of a conflict in terminology, the present specification is controlling.

It is noted that any one or more aspects or features described with respect to one embodiment may be incorporated in a different embodiment although not specifically described relative thereto. That is, all embodiments and/or features of any embodiment can be combined in any way and/or combination. Applicant reserves the right to change any originally filed claim or file any new claim accordingly, including the right to be able to amend any originally filed claim to depend from and/or incorporate any feature of any other claim although not originally claimed in that manner. These and other objects and/or aspects of the present invention are explained in detail in the specification set forth below.

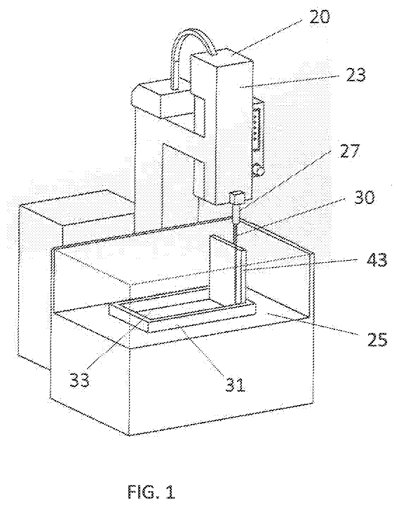

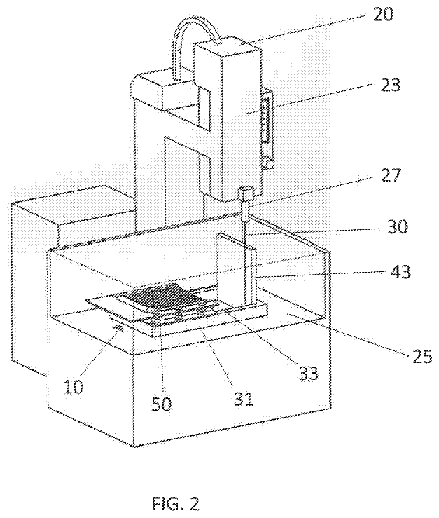

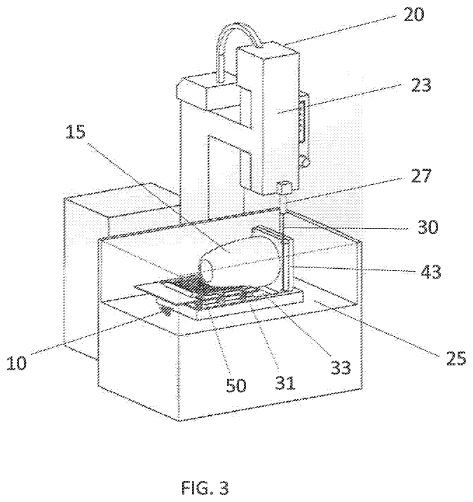

The present disclosure relates to a removal system 10 for aiding in the removal of an article of manufacture 15 produced by additive manufacturing in combination with an electric discharge machine (EDM) 20. As shown in FIG. 1, the EDM 20 may include a main machine body 23, and dielectric fluid unit 25, an upper wire guide 27 and a wire electrode 30. Within the dielectric fluid unit 25 is a base 31 having a floor surface 33. Referring to FIG. 2, the removal system 10 is mounted on the floor surface 33 of the base 31 of the EDM 20. Also mounted on the floor surface 33 is a support plate 43 wherein an article of manufacture 15 on a build plate 40 may be positioned on the build plate as shown in FIG. 3.

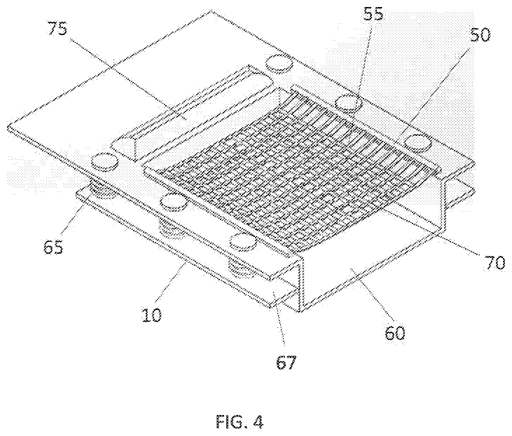

Referring to FIGS. 2-4, the removal system 10 comprises a catch mechanism 50 disposed below the build plate surface. The catch mechanism 50 may include a catch basket 55. The catch mechanism 50 is mounted on a support surface 60 and includes spring mechanism 65 on a suspension mount 67. The support surface 60 may be adjustable to facilitate use with multiple EDM's with different height drops. To facilitate removal (by catching) a net 70 may be disposed across the catch basket at a distance above a bottom portion of the catch basket 55. The catch mechanism 50 may also include a polymeric stop 75 to facilitate avoidance of the article of manufacture damaging the dielectric fluid unit 25 when removed from the build plate 40.

In operation, the article of manufacture (part) 15 is removed from the build plate 40 using EDM 20 and the wire electrode 30. Once the article 15 is completely removed, namely cut off the build plate 40, the article falls into the catch mechanism 50. The catch mechanism and the support structure 60 thereof including the catch basket 55, the netting 70, the springs 65 and the polymeric stop 75 cushions or dampens the fall of the article of manufacture into the catch basket 55 of the catch mechanism 50.

It will be understood that certain features and subcombinations are of utility and may be employed without reference to other features and subcombinations and are contemplated within the scope of the claims.

That which is claimed is:

1. A removal system for aiding in the removal of an article of manufacture produced by additive manufacturing from a build plate, the system comprising:
a catch mechanism disposed below the build plate surface, the catch mechanism comprising a catch basket;
a support surface to which the catch mechanism is mounted and including a spring mechanism; and
a net disposed across the catch basket at a distance above a bottom portion of the catch basket.

2. A system according to claim 1, wherein the catch mechanism includes a polymeric stop for dampening the fall of the article of manufacture.

3. A removal system according to claim 1 in combination with an EDM.

4. A removal system according to claim 2 in combination with an EDM.

5. A method of removing an article of manufacture produced using additive manufacture from a build plate, the method comprising:
positioning a catching mechanism below a build plate surface having an article of manufacture thereon wherein the catching mechanism comprises a catch basket;
removing the article of manufacture from the build plate using EDM; and,
catching the article of manufacture after it is removed from the build plate.
